(19) United States
(12) Patent Application Publication
(10) Pub. No.: US 2026/0338664 A1
(43) Pub. Date: Oct. 29, 2026

(54) Method of Microbubble Resonator Fabrication

(71) Applicant: The Regents of the University of California, Oakland, CA (US)

(72) Inventors: Abraham J. QAVI, Chino Hills, CA (US); Minsu JANG, Irvine, CA (US); Ubaid ULLAH, Irvine, CA (US); Angela LI, Baldwin Park, CA (US)

(73) Assignee: The Regents of the University of California, Oakland, CA (US)

(21) Appl. No.: 19/659,728

(22) Filed: Apr. 27, 2026

Related U.S. Application Data
(60) Provisional application No. 63/794,871, filed on Apr. 25, 2025.

(51) Int. Cl. G01N 15/1434; B23K 26/352

(52) U.S. Cl. CPC G01N 15/1434; B23K 26/352

(57) ABSTRACT

A method for fabricating symmetric microbubble resonators (MBRs) has been developed using a CO₂ laser in combination with an automated rotational system, eliminating the need for pre-tapered capillary tubes. This technique ensures uniform heat distribution around the capillary and supports the creation of MBRs with diameters spanning from micrometers to millimeters. The system, built from readily available off-the-shelf components, is simple to set up and replicate. By carefully regulating internal pressure and laser power, the process yields smooth, structurally robust resonators. The resulting MBRs exhibit Q-factors greater than 10⁷, indicating strong potential for high-performance sensing applications. Their compatibility with standard components also supports easy integration into microfluidic systems, broadening their application range.

### CROSS-REFERENCE TO RELATED APPLICATIONS

This application claims the benefit of U.S. provisional application Ser. No. 63/794,871 filed Apr. 25, 2025, the disclosure of which is hereby incorporated in its entirety by reference herein.

### STATEMENT REGARDING FEDERALLY SPONSORED RESEARCH OR DEVELOPMENT

This invention was made with government support under EB033409 awarded by the National Institutes of Health. The government has certain rights in the invention.

### TECHNICAL FIELD

In at least one aspect, the present invention relates to the field of optical sensing and microresonator fabrication. More specifically, it pertains to methods and apparatuses for fabricating whispering gallery mode (WGM) microbubble resonators using laser-based heating systems and to the use of such resonators in high-sensitivity analyte detection applications.

### BACKGROUND

Whispering Gallery Mode (WGM) sensors are renowned for their exceptional sensitivity, capable of detecting single particles [1,2]. This remarkable sensitivity allows for the detection of nanoscale particles such as viruses [3], and enables real-time monitoring of molecular dynamics, including DNA binding events [4]. The operational principle of WGM sensors relies on the confinement of light within a resonator, where the light undergoes continuous internal reflections along the surface of resonator, repeatedly interacting with surrounding analytes. This repeated interaction between the light and the target analyte amplifies the detection signal, enhancing the sensor's performance. Resonators supporting WGMs come in various geometries, such as microrings [5], microtoroids [6], microspheres [7], microdroplets [8], and microbubbles [9]. Among these, microbubble resonators (MBRs) have attracted considerable attention due to their hollow cavity structure, which is connected on both ends by capillary tubing. This unique design facilitates integrated fluid flow through the resonator, making MBRs particularly advantageous for biosensing applications where the efficient handling of liquid samples is crucial.

The fabrication of MBRs typically involves applying internal pressure to a capillary tube while locally heating it to induce expansion. Common heat sources for this process include oxyhydrogen flame heating [10], arc discharge [11], and CO2 lasers [12,13]. However, each of these methods presents distinct challenges. Heating with an oxyhydrogen flame requires precise control of gas flow rates to regulate the size and intensity of the flame. Despite this control, achieving uniform heat distribution can be difficult due to environmental factors such as air turbulence and gas flow instability. Arc discharge, while capable of producing localized heating, demands complex and costly equipment to maintain stable arc conditions, and the rapid temperature fluctuations can lead to micro-cracks in the glass material. In contrast, CO2 lasers offer significant advantages in terms of thermal stability and precision. The laser's ability to consistently deliver focused heat to specific regions allows for better control over the fabrication process and facilitates the creation of resonators with uniform geometries.

Previous studies have successfully demonstrated the fabrication of high-Q microbubble and microbottle resonators using CO₂ lasers [14-16]. Achieving a symmetric structure with a smooth surface is critical, as imperfections can lead to scattering losses that degrade the Q-factor. However, the highly focused nature of the CO₂ laser beam makes it challenging to distribute heat uniformly across the entire circumference of the capillary tube. To overcome this issue, many researchers have employed a pre-tapering process, reducing the capillary's diameter to between 10 and 30 μm before laser irradiation. This approach promotes more uniform thermal diffusion, but it also imposes significant limitations on the final resonator structure. The diameter of the fabricated MBRs is often restricted to below 100 μm, which limits their applications.

Accordingly, there is a need for a simplified and scalable method to fabricate microbubble resonators without requiring pre-tapered capillaries.

### SUMMARY

In at least one aspect, a novel method for fabricating MBRs with diameters ranging from micrometers to millimeters without the need for pre-tapering the capillary tube addresses the limitations of the prior art. By implementing an automated rotational system, uniform heat distribution around the tube's circumference is ensured, which is essential for producing symmetric MBRs with smooth surfaces that minimize scattering losses. Furthermore, the effects of CO₂ laser power and the internal pressure of the capillary tube on the fabrication speed and the resulting MBR size is also investigated. This approach provides a versatile framework for optimizing the fabrication process to meet the specific requirements of various sensing applications. Finally, the Q-factors of MBRs of different sizes are investigated to demonstrate the potential for creating high-performance WGM sensors that overcome the limitations of conventional fabrication techniques.

In another aspect, a method for fabricating a whispering gallery mode (WGM) optical resonator including a microbubble structure is provided. The method includes a step of providing a capillary tube and sealing its first end. In a refinement, capillary tube is composed of a transparent material. A pressure source is connected to the second end of the tube to introduce and maintain a predetermined internal pressure. The capillary tube is mounted onto a motorized rotation assembly configured to rotate the tube about its longitudinal axis. A section of the capillary is then aligned with a laser-based optical heating system designed to deliver substantially symmetrical heat from opposing directions. While the tube rotates, the laser system is activated to heat a portion of the capillary, causing it to soften and expand under the internal pressure to form a microbubble. Heating and rotation are subsequently stopped by ceasing heating and rotation upon formation of the microbubble, yielding a microbubble resonator with a high optical quality factor.

In another aspect, an apparatus for fabricating a whispering gallery mode (WGM) optical resonator is provided. The apparatus includes a capillary tube composed of a transparent material, with one end sealed and the opposing end configured to be pressurized. A pressure source is coupled to the pressurizable end to maintain a controlled internal pressure within the tube. A laser-based optical heating system is positioned to apply substantially symmetrical heat to a selected region of the capillary tube. The apparatus further comprises a motorized rotation assembly, which includes a tube holder and a motor, where the tube holder is designed to securely hold and rotate the capillary tube about its longitudinal axis during heating. A control system is integrated to synchronize the laser heating and rotational motion, enabling the formation of a spherical microbubble structure with a high optical quality factor.

In another aspect, a method is provided for detecting an analyte using a microbubble resonator fabricated by the method described above. The method comprises introducing a fluid sample containing the analyte into the interior of the microbubble, directing a light beam into the resonator to induce a whispering gallery mode, and detecting an analyte. In a refinement, a resonance wavelength shift can be detected that occurs in response to the presence of the analyte. It should be appreciated that a variety of detection methods can be applied, including but not limited to resonance peak (mode) shift, mode widening, and mode splitting.

In another aspect, a method of detecting nanoparticles using a microbubble resonator fabricated by the method described above is provided. The method includes introducing a fluid sample containing nanoparticles into the interior of the microbubble, directing a light beam into the resonator to induce a whispering gallery mode having an optical quality factor greater than 10⁷, and detecting mode splitting in a transmission spectrum of the resonator. The introduction of nanoparticles having a size in a range of 10 nm to 100 nm into an ultra-high Q cavity leads to the generation of degenerate modes that manifest as mode splitting, wherein a single resonance peak separates into a symmetric mode and an asymmetric mode. In a refinement, a degree of mode splitting increases with increasing concentration of nanoparticles within a cavity of the microbubble. In a refinement, the nanoparticles include intact virions, and the method provides label-free detection of the nanoparticles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a further understanding of the nature, objects, and advantages of the present disclosure, reference should be made to the following detailed description, read in conjunction with the following drawings, wherein like reference numerals denote like elements and wherein:

FIGS. 1A and 1B. Setup for MBR fabrication. (A) Schematic of the CO₂ laser configuration for symmetric heating (M: Mirror, L: Lens, and S: Splitter), and (B) rendering of the automated rotational mechanism designed to ensure uniform thermal distribution around capillary tube. The red arrow indicates the assembly direction of the 3D-printed connector.

FIG. 2. MBR expansion rate as a function of laser power and internal pressure of the capillary tube. Star symbols indicate the point of MBR rupture. The inset shows the expansion rates at higher pressures (3 bar and 5 bar). The right panel displays optical microscope images of MBR expansion captured at different time intervals (Scale bar: 1 mm).

FIG. 3. Diameter of expanded MBRs as a function of laser power. All experiments were conducted under an internal pressure of 1.5 bar (n=3). The red star indicates the diameter of MBRs just before bursting during expansion.

FIG. 4. WGM signals obtained from MBRs with different diameters.

FIGS. 5A, 5B, 5C, and 5D. Representative peak graphs of WGM signals obtained from MBRs with different diameters, showing high Q-factors. (A) MBR with a diameter of 445 μm, Q-factor: 3.81×10⁷, (B) MBR with a diameter of 680 μm, Q-factor: 5.70×10⁶, (C) MBR with a diameter of 1213 μm, Q-factor: 1.89×10⁷, (D) MBR with a diameter of 1905 μm, Q-factor: 2.60×10⁶. The black lines and markers represent the experimentally measured values, while the red lines indicate Lorentzian fitting.

FIGS. 6A and 6B. Mode splitting in a microbubble resonator. A: transmission spectra showing the evolution of mode splitting with increasing nanoparticle concentration from deionized water (DIW) through 2.5×10⁻⁶ to 2.5×10⁻² wt %. B; detailed view of the split resonance at a concentration of 2.5×10⁻⁴ wt %, showing the asymmetric mode (ASM) and symmetric mode (SM) peaks, their respective wavelengths (λ_{ASM}, λ_{SM}), linewidths (γ₁, γ₂), and the splitting distance (δ).

FIG. 7. Transmission spectra of a microbubble resonator over a range of nanoparticle concentrations from air through deionized water (DIW) and 10⁻⁶ to 10⁻² wt %. A tracked resonance peak shows a progressive shift in resonance wavelength from approximately 780.065 nm to 780.052 nm with increasing nanoparticle concentration, demonstrating the sensitivity of the whispering gallery mode resonance to the presence and concentration of nanoparticles within a cavity of the microbubble.

FIGS. 8A and 8B. Whispering gallery mode resonance wavelength shifts in a microbubble resonator as a function of saline concentration. a: transmission spectra showing resonance peak shifts at saline concentrations of 0, 5, 10, 15, 100, and 1000 mM. B: peak wavelength as a function of saline concentration from 0 to 100 mM, showing saturation above 100 Mm and wavelength shift in the linear response regime from 0 to 15 mM, demonstrating a sensitivity of approximately 1.14 pm/mM.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

Throughout this application, where publications are referenced, the disclosures of these publications in their entireties are hereby incorporated by reference into this application to more fully describe the state of the art to which this invention pertains.

### ABBREVIATIONS

“CO₂” means carbon dioxide; in the context of the application, it refers to a CO₂ laser used as a heating source.

“GHz” means gigahertz, a unit of frequency equal to one billion hertz.

“ID” means inner diameter; refers to the internal dimension of the capillary tube.

“MBR” means microbubble resonator.

“n” means the effective refractive index in the context of the resonance wavelength equation.

“Q” means quality factor, a dimensionless parameter that describes the sharpness of resonance in optical systems.

“r” means the radius of the microbubble resonator.

“WGM” means whispering gallery mode, a type of optical resonance caused by light waves circulating along the inner surface of a curved dielectric structure.

“μm” means micrometer, which is one-millionth of a meter.

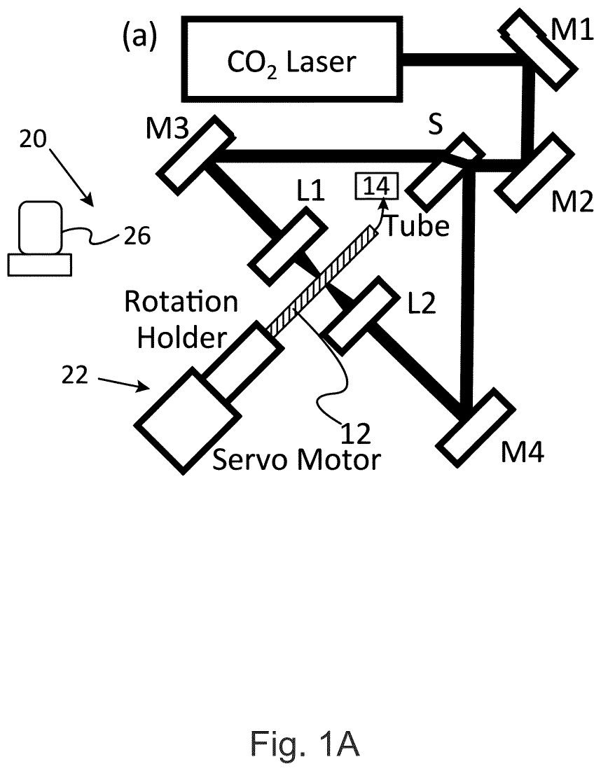

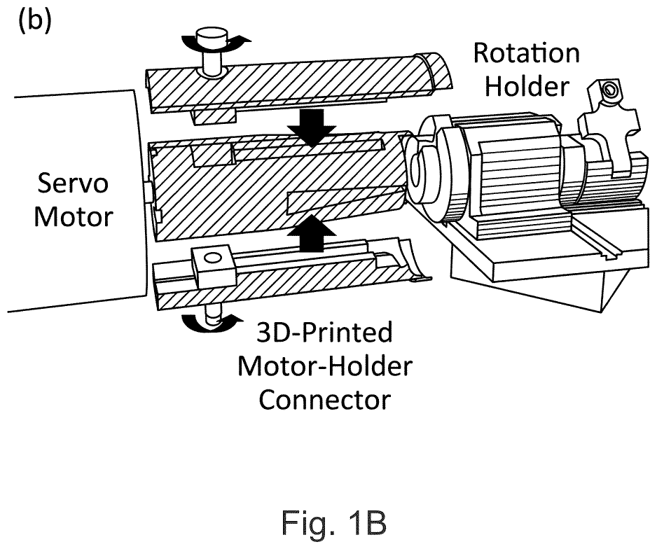

Referring to FIG. 1A, a schematic of an apparatus for fabricating a whispering gallery mode (WGM) optical resonator is provided. The apparatus 10 includes a capillary tube 12 composed of a transparent material, with one end sealed and an opposing pressurizable end configured to be pressurized. In a refinement, the transparent material is fused silica. A pressure source 14 is coupled to the pressurizable end to maintain a controlled internal pressure within the tube. A laser-based optical heating system 20 is positioned to apply substantially symmetrical heat to a selected region of the capillary tube. The apparatus further comprises an automated rotation assembly 22, which includes a tube holder and a motor, where the tube holder is designed to securely hold and rotate the capillary tube about its longitudinal axis during heating. A control system is integrated to synchronize the laser heating and rotational motion, enabling the formation of a spherical microbubble structure with a high optical quality factor (e.g., greater than 10⁶). In a refinement, the control system comprises a microcontroller programmed to rotate the capillary tube in alternating directions through predefined angular displacements.

In another aspect, the laser-based optical heating system includes a CO₂ laser, a beam splitter, and a plurality of mirrors and lenses configured to direct equal-intensity laser beams onto opposing sides of the capillary tube, as depicted in FIG. 1A.

In certain embodiments, a method for fabricating a whispering gallery mode (WGM) optical resonator comprising a microbubble structure is provided. The method includes a step of providing a capillary tube composed of a transparent material, such as fused silica, and sealing a first end of the tube. A pressure source is connected to the second end of the capillary to introduce and maintain a predetermined internal pressure. The capillary tube is mounted onto an automated rotation system configured to rotate the capillary tube in a back-and-forth direction or continuously about its longitudinal axis, wherein the automated rotation system is designed to ensure uniform circumferential heat distribution during fabrication. A section of the capillary tube is aligned with a laser-based optical heating system, which as set forth above may include a CO₂ laser, a beam splitter, and a plurality of mirrors arranged to deliver substantially symmetrical heat from opposing directions (i.e., to deliver equal laser power to opposing sides of the capillary tube.) While the tube is rotating, the laser-based heating system is activated to heat a specific portion (i.e., a heated portion) of the capillary, causing it to soften and expand under the applied internal pressure to form a microbubble. Once the desired expansion is achieved, ceasing heating and rotation upon formation of the microbubble yields a microbubble resonator with a high optical quality factor.

In another aspect, the motorized rotation assembly comprises a servo motor coupled to an encoder, and the system may be programmed to rotate the capillary tube in alternating clockwise and counterclockwise directions. The rotation protocol may include at least one ±180° rotation and/or at least one ±360° rotation to ensure uniform heat distribution across the tube's circumference. Prior to heating, a polymer coating may optionally be removed if present from the surface of the capillary tube to improve thermal uniformity. In a refinement, the internal pressure may be regulated using a syringe connected to the second end of the tube via a fluidic connector such as Luer Lock connectors or compression fittings.

The size of the resulting microbubble may be controlled by adjusting one or more fabrication parameters, including laser power, internal pressure, and/or heating duration.

In another aspect, the method further includes a step of reconstructing a three-dimensional morphology of the microbubble using video frames from a fabrication process of the microbubble. In a refinement, the reconstruction can include a step of applying a machine learning algorithm to segment and render a three-dimensional surface geometry of the microbubble.

In a refinement, the automated rotation system 22 includes rotational motor via custom-designed 3D-printed holders. The holders are configured to support the capillary tube without imposing mechanical stress and to allow stable bidirectional rotation during heating. In a refinement, the custom-designed 3D-printed holders include a pillar structure configured to extend from a motor's rotating shaft, the pillar having a central groove to support the capillary tube and a lower hole to receive the motor shaft. In another refinement, the custom-designed 3D-printed holders further comprises wing components that connect the pillar to a tube holder, the wings including latch mechanisms configured to lock into grooves of the tube holder to secure the capillary tube. In a further refinement, the pillar and wing components are assembled using mechanical fasteners comprising bolts and nuts.

In another aspect, an alignment guide structure having grooved surfaces is used to stably support the capillary tube during rotation and reduce vibrations or misalignment. In a refinement, a weighted flat structure is placed atop the capillary tube within the alignment guide grooves to suppress displacement during rotation.

In another aspect, a detachment structure is configured to safely secure the capillary tube after microbubble formation. The structure allows the tube to be fixed at both ends and separated from the rotation system without applying external stress. In a refinement, the detachment structure is attachable to the alignment guide structure and includes adhesive regions for fixing both ends of the capillary tube.

In another aspect, the rotation angle is modulated periodically or aperiodically during heating to suppress asymmetrical thermal gradients and to enhance microbubble symmetry.

In another aspect, the automated rotation system includes a programmable controller for adjusting rotation speed, direction, and angle during fabrication to optimize bubble geometry.

In another embodiment, a method of detecting an analyte with a microbubble resonator fabricated by the methods set forth above is provided. The method includes a step of introducing a fluid sample containing the analyte into the interior of the microbubble. A light beam (e.g., a laser) is directed into the resonator to induce a whispering gallery mode. A resonance wavelength shift in response to the presence of the analyte is detected. Examples of analytes include but are not limited to a virus, protein, nucleic acid, gas, or salt ion. In particular, the detecting includes a step of quantitatively determining a concentration of the analyte by comparing a measured resonance wavelength shift to a calibration curve established from solutions of known concentrations of the analyte. For example, the analyte can include a salt ion where the resonance wavelength shift exhibits a linear relationship with a concentration of the salt ion over a predetermined concentration range.

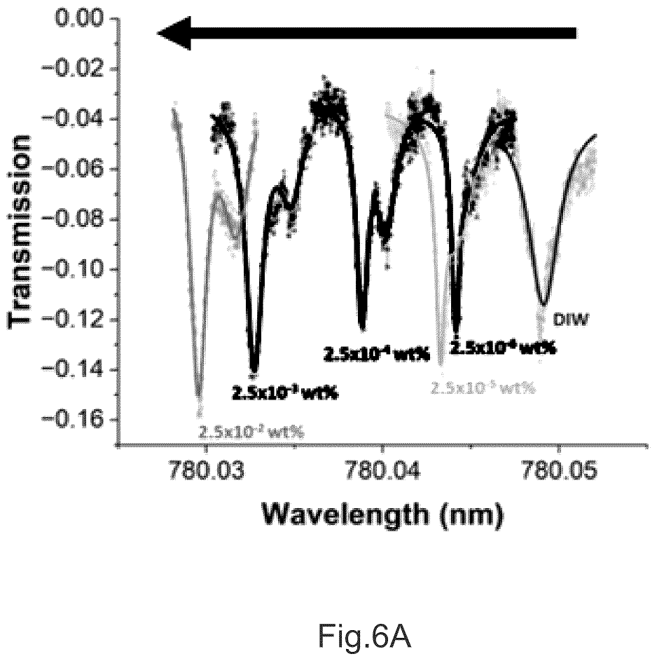

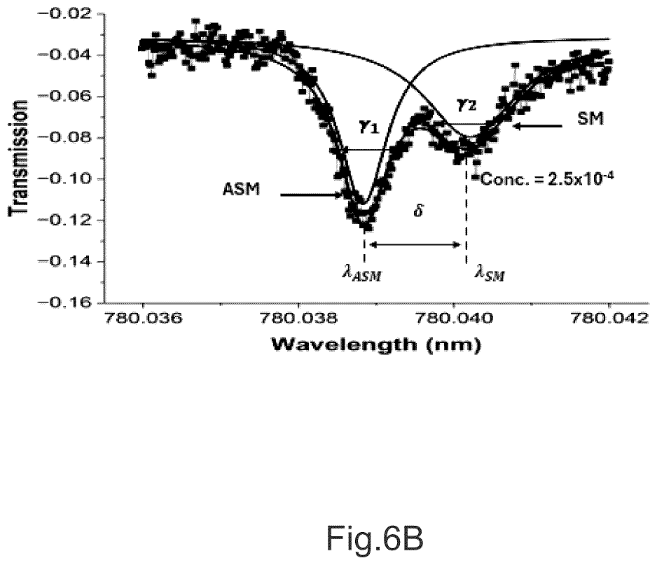

In another embodiment, a method of detecting nanoparticles using mode splitting in a microbubble resonator fabricated by the methods set forth above is provided. With ultra-high Q cavities (e.g., Q greater than 10⁷), the introduction of nanoparticles having a size in a range of 10 nm to 100 nm into the cavity leads to the generation of degenerate modes that manifest as mode splitting in the transmission spectrum. Mode splitting occurs when a single resonance peak separates into two peaks corresponding to a symmetric mode (SM) and an asymmetric mode (ASM). The method includes a step of introducing a fluid sample containing nanoparticles into the interior of the microbubble. A light beam is directed into the resonator to induce a whispering gallery mode. A transmission spectrum of the resonator is monitored, and mode splitting is detected as the nanoparticles interact with the evanescent field of the whispering gallery mode. As shown in FIG. 6, increasing nanoparticle concentration from deionized water through 2.5×10⁻⁶ to 2.5×10⁻² wt % produces progressively greater mode splitting, with the split resonance exhibiting distinct ASM and SM peaks separated by a splitting distance δ. In a refinement, the degree of mode splitting (i.e., the frequency separation between the SM and ASM peaks) increases with increasing concentration of nanoparticles within a cavity of the microbubble.

In a refinement, the nanoparticles include intact virions, and the method provides label-free detection of the virions without requiring fluorescent labels or other tagging agents. In another refinement, the mode splitting is used to determine a size and/or concentration of the nanoparticles based on calibration data relating the magnitude of mode splitting to known particle sizes and concentrations. Advantageously, the mode splitting detection approach provides single-particle sensitivity, enabling the detection and characterization of individual nanoparticles as they enter the resonator cavity.

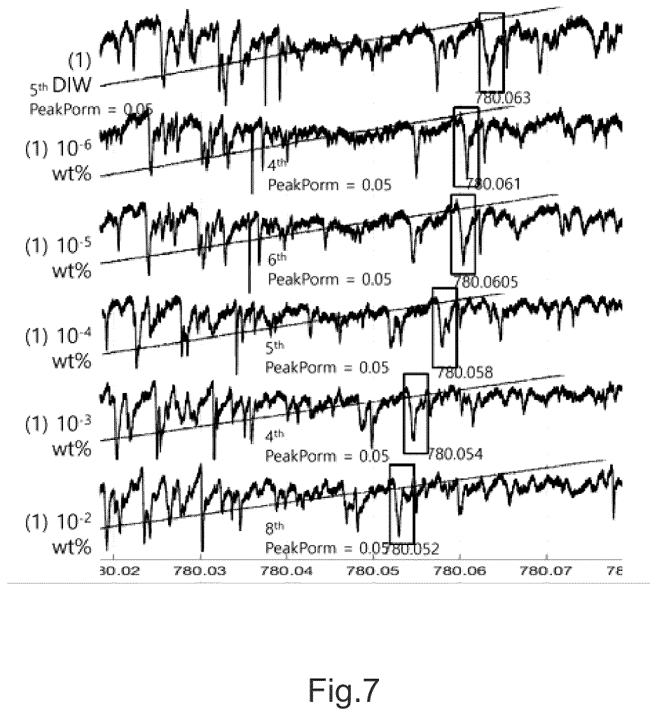

In another embodiment, a method of detecting the presence and concentration of nanoparticles using resonance wavelength shifts in a microbubble resonator fabricated by the methods set forth above is provided. As shown in FIG. 7, the introduction of nanoparticles into the cavity of the microbubble resonator produces a progressive shift in the resonance wavelength of the whispering gallery mode. The resonance wavelength shifts from approximately 780.065 nm in air to approximately 780.052 nm at a nanoparticle concentration of 10⁻² wt %, with intermediate concentrations producing intermediate shifts. The method includes a step of introducing a fluid sample containing nanoparticles at varying concentrations into the interior of the microbubble, directing a light beam into the resonator to induce a whispering gallery mode, and tracking the resonance wavelength as a function of nanoparticle concentration. In a refinement, the resonance wavelength shift is correlated to the nanoparticle concentration using a calibration curve established from known concentrations.

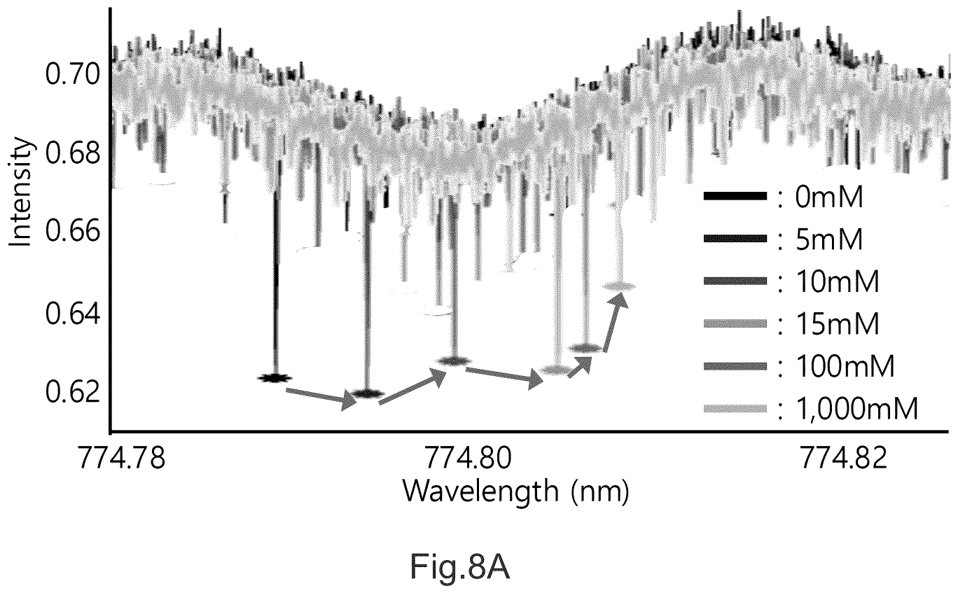

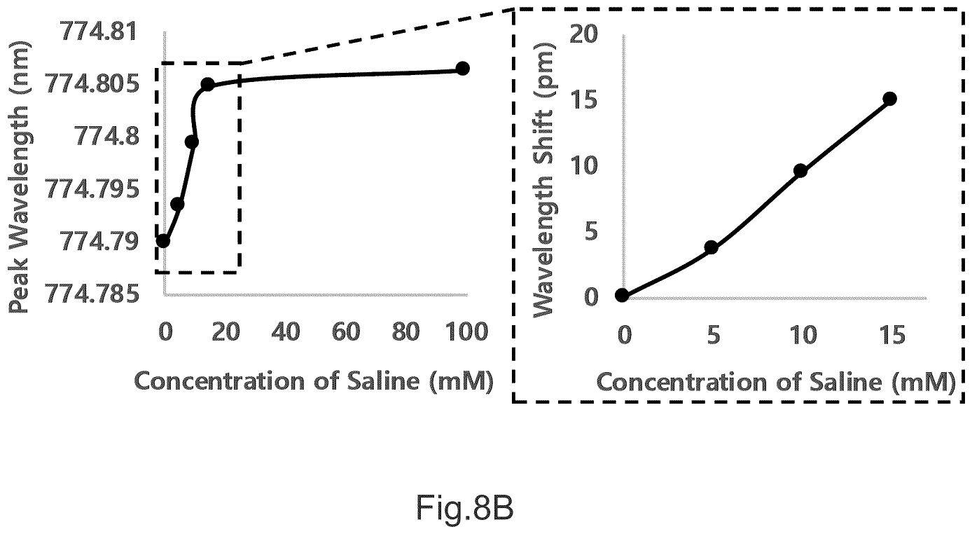

In another embodiment, a method of quantitatively determining a concentration of a salt ion in a fluid sample using a microbubble resonator fabricated by the methods set forth above is provided. As shown in FIG. 8, the resonance wavelength of the whispering gallery mode shifts in response to the introduction of saline solutions at varying concentrations into the cavity of the microbubble resonator. Resonance peak shifts were observed at saline concentrations of 5, 10, 15, 100, and 1000 mM, with the signal becoming saturated at concentrations above approximately 100 mM. In the concentration range of 0 to 15 mM, a linear relationship between the wavelength shift and the saline concentration is observed, with a sensitivity of approximately 1.14 pm/mM. The method includes a step of introducing a fluid sample containing the salt ion into the interior of the microbubble, directing a light beam into the resonator to induce a whispering gallery mode, and detecting a resonance wavelength shift. In a refinement, the concentration of the salt ion is determined by comparing the measured resonance wavelength shift to a calibration curve established from saline solutions of known concentrations in the linear response regime. In a refinement, the salt ion includes sodium chloride.

In another embodiment, a method of detecting a change in viscosity of a fluid using a microbubble resonator fabricated by the methods set forth above is provided. The microbubble resonator's thin-walled structure supports optomechanical coupling between circulating optical whispering gallery modes and mechanical vibrations of the microbubble wall. In operation, a fluid sample is introduced into the interior of the microbubble, and a light beam is directed into the resonator to induce a whispering gallery mode. The whispering gallery mode produces optomechanical coupling that generates mechanical vibrations of the microbubble resonator at a characteristic mechanical vibration frequency. The mechanical vibration frequency is monitored, and a shift in the mechanical vibration frequency is detected in response to a change in viscosity of the fluid sample. In a refinement, the fluid sample includes a biological fluid, such as whole blood or plasma, and changes in the mechanical vibration frequency over time are indicative of a coagulation event. By monitoring the mechanical vibration frequency of the microbubble resonator in real time, the onset and progression of coagulation in a biological fluid can be tracked. In a further refinement, the biological fluid includes whole blood or plasma, and the method enables assessment of coagulation status without requiring chemical reagents.

In another aspect, a whispering gallery mode (WGM) optical resonator made by the methods set forth above is provided. The whispering gallery mode optical resonator includes a microbubble structure formed from a transparent capillary tube. Typically, the microbubble has a spherical or near-spherical geometry, an internal cavity, and a continuous outer wall with a smooth surface. Characteristically, the microbubble is formed by expanding a section of the capillary tube under internal pressure while subjected to symmetrical heating from opposing directions during rotation about its longitudinal axis. Advantageously, the resonator exhibits an optical quality (Q) factor greater than 10⁶. In a refinement, the Q-factor exceeds 10⁷.

In another aspect, the outer wall of the microbubble has a thickness of less than 3 micrometers. In a refinement, the diameter of the microbubble is between 100 micrometers and 2 millimeters.

In another aspect, the geometry of the microbubble is symmetric about its longitudinal axis with less than 5% deviation in wall thickness along a circumference thereof.

In another aspect, the microbubble is fluidically accessible through opposing ends of the capillary tube for the introduction of a liquid or gas sample. Advantageously, the resonator is integrated into a microfluidic platform for analyte detection via resonance wavelength shifts.

The following examples illustrate the various embodiments of the present invention. Those skilled in the art will recognize many variations that are within the spirit of the present invention and scope of the claims.

FIG. 1 illustrates the experimental setup for the fabrication of microbubble resonators (MBRs). A CO₂ laser (Diamond C-30, Coherent, USA) is employed as the heat source, with beams directed symmetrically from both sides of the capillary tube to facilitate the formation of uniformly structured MBRs. To ensure even heat distribution along the entire circumference of the tube within a specific longitudinal section, the distance between the focusing lens and the tube was precisely adjusted so that the 325 μm outer diameter of the capillary tube was fully encompassed within the laser's focal area. Considering that the CO₂ laser emits a beam with an approximate diameter of 2 mm, and using a 25 mm diameter ZnSe lens (Cloudray, USA) with a focal length of 63.5 mm, the optimal lens-to-tube distance was fixed at around 52 mm. This configuration produced a laser beam with a diameter of approximately 360 μm on the tube surface.

When the CO₂ laser beam was focused on a centrally fixed tube, symmetrical hemispherical expansions of MBR formed on both sides. However, holding the tube in a static position with prolonged laser exposure resulted in an elliptical-shaped MBR, which is unsuitable for sustaining WGMs due to curvature-induced optical losses. To overcome this limitation and achieve a fully spherical MBR, it was essential to distribute the laser heat uniformly along the entire circumference of the tube. This was accomplished by implementing an automated rotation system using a rotatable fiber holder (Thorlabs, USA) connected to a servo motor with an integrated encoder (Pololu, USA). Controlled by an Arduino, the system enabled precise back-and-forth (oscillatory) rotation between +180° and −180° at a constant angular speed of 90 degrees per second. To prevent misalignment caused by vibrations or mechanical eccentricities during rotation, a 3D-printed tube guide with a groove structure was employed to restrict linear displacement and maintain the tube's position within the laser's focal area.

The base material for MBR fabrication was a silica capillary tube (BGB Analytik, Germany) with an inner diameter of 250 μm and an outer diameter of 325 μm after removing the coating, which had a thickness of about 18 μm. Internal pressure was applied using a syringe (1005TLL, Hamilton, USA) connected via a luer lock connector (IDEX, USA) for secure attachment. The opposite end of the tube was sealed with hot glue to prevent pressure leakage. The tube was mounted on the rotatable holder, ensuring uniform laser exposure as it rotated.

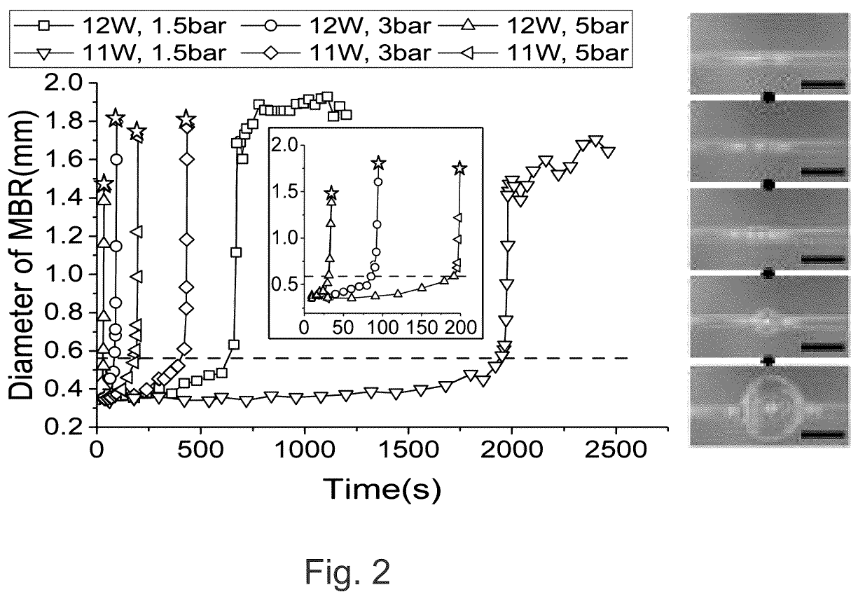

The formation of MBRs relies on heating the silica tube to elevate its temperature beyond the glass transition point, transforming the material into a viscoelastic state. This thermal softening, combined with internal pressure, causes the hollow cavity to expand. As the CO₂ laser heats the outer wall of the silica tube, the thermal energy gradually transfers inward. Initial expansion occurs slowly due to the high viscosity of silica at lower temperatures. However, once the temperature approaches the viscosity threshold, the material softens significantly, and when the applied stress exceeds the yield point, rapid expansion ensues. This process results in a stepwise inflation pattern, as shown in FIG. 2.

Rapid expansion can be achieved by either increasing the thermal input through higher laser power or applying greater internal pressure to enhance the driving force behind the expansion. As demonstrated in FIG. 2, using high laser intensity and elevated internal pressure enables the fabrication of MBRs within a matter of minutes. Interestingly, the initial expansion rate remains slow even under high-power and high-pressure conditions, indicating that the viscoelastic behavior of silica and heat transfer dynamics govern the early stages of bubble formation, consistent with observations under lower power and pressure conditions.

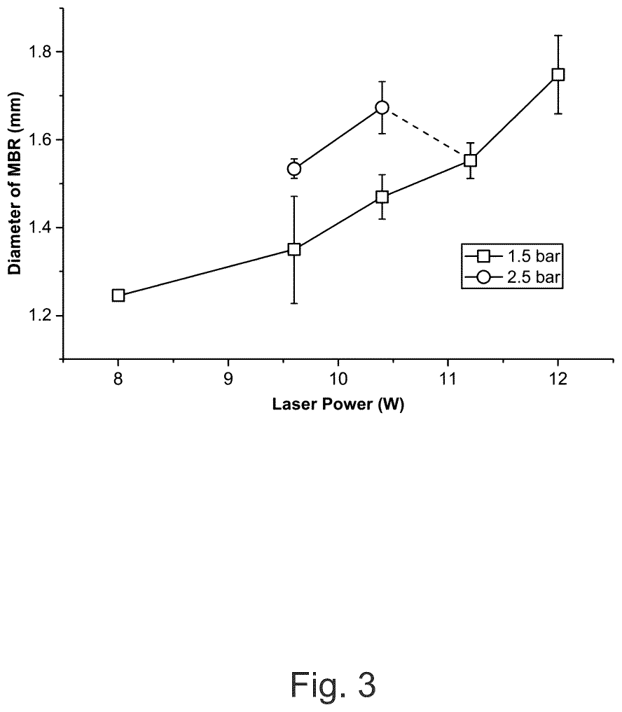

While high internal pressure accelerates fabrication, it also introduces risks associated with Laplace's Law, where increased pressure generates substantial stress on the silica structure. If the silica's viscosity has not sufficiently decreased due to heating, this stress can rapidly exceed the material's mechanical limits, causing fractures. Experimental observations confirmed that MBR formation is feasible even under low laser power with high internal pressure, suggesting the potential for optimizing the balance between thermal input and mechanical stress to control resonator size and structural integrity. Conversely, variations in laser power influence the rate of thermal energy deposition, and as the MBR diameter increases, the expanded surface area accelerates cooling, creating a dynamic equilibrium that affects the final size of the resonator. FIG. 3 shows that applying 8 W of laser power produces MBRs with diameters of approximately 1.25 mm, corresponding to a wall thickness of around 2.52 μm. In contrast, increasing the laser power to 12 W enables the formation of MBRs up to 1.75 mm in diameter, with wall thicknesses of approximately 1.63 μm. The wall thickness of the MBR was theoretically calculated using a geometrical approach based on the assumption of volume conservation of the tube before and after expansion, as referenced in [17].

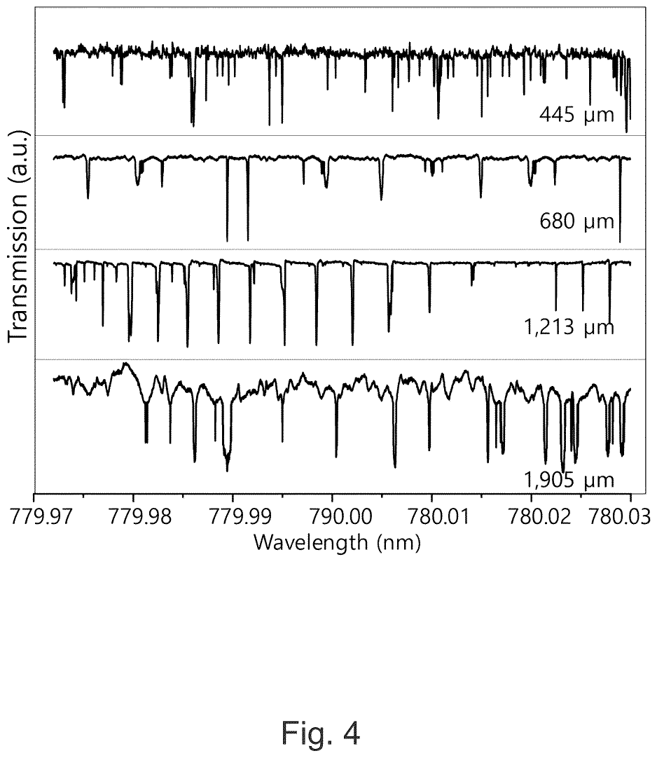

To evaluate the optical performance of the fabricated MBRs, the Q-factor was measured using a tapered fiber with a diameter of approximately 2 μm for efficient light coupling. To fabricate the tapered fiber, we stretched a single-mode fiber using an oxyhydrogen flame. A photodetector (1801-FS, Newport, USA) and an oscilloscope (Tektronix, USA) were employed to detect the resonance signals, while a tunable laser (TLB-6700, Newport, USA) centered at 780 nm, sweeping over a range of 50 GHz, was used to excite the whispering gallery modes. FIG. 4 shows the transmission spectra measured from MBRs with four different diameters. The resonance wavelength varies with diameter, which can be inferred from the theoretical equation for calculating the resonance wavelength (λ):

mλ=2πRn_{eff}

where m is the azimuthal quantum number, R is the radius of the MBR, and n_{eff} represents the effective refractive index of the WGM.

Additionally, the MBR with a diameter of 445 μm exhibits a higher mode density in the spectrum compared to MBRs of other diameters. This is because the 445 μm MBR has a bottle-shaped elongated resonator geometry, leading to an increased degeneracy of polarization modes due to the broken degeneracy between WGM modes with a common azimuthal and different axial modes [18]. In contrast, MBRs with diameters greater than 680 μm exhibit a spherical shape, where low-order modes near the equator are tightly confined, resulting in signals with a broad free spectral range.

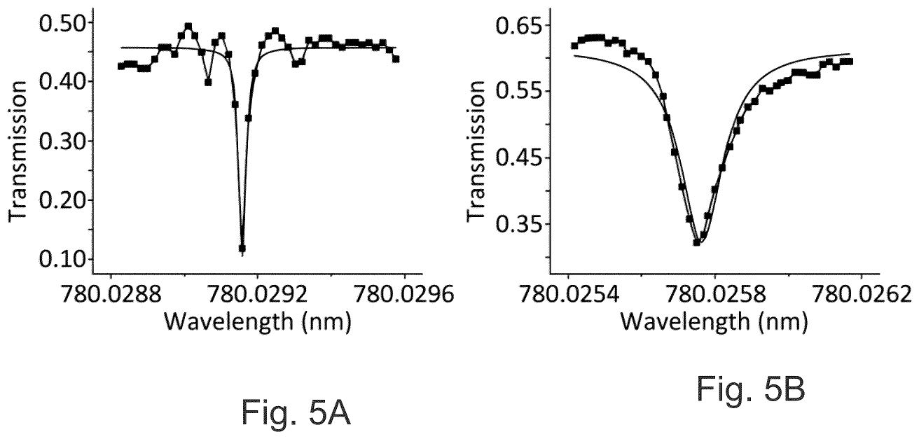

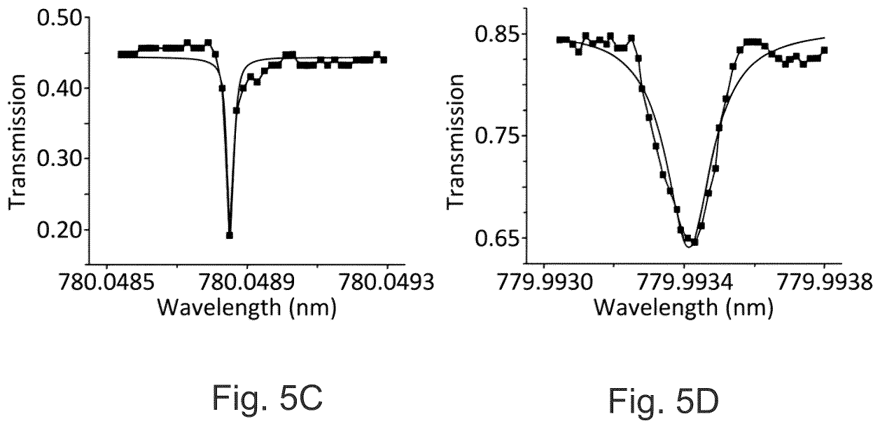

FIG. 5 presents selected representative resonance peaks from the transmission spectra of the four different MBR diameters shown in FIG. 4 to measure the full width at half maximum (Δλ) and the Q-factor. The Q-factor was inferred using the formula Q=λ/Δλ. High Q-factors of 3.81×10⁷ and 1.89×10⁷ were measured in the 445 μm and 1213 μm diameter MBRs, respectively. In contrast, MBRs with diameters of 680 μm and 1905 μm exhibited relatively lower Q-factors of 5.70×10⁶ and 2.60×10⁶, respectively. The total Q-factor of the MBR can be expressed as the reciprocal of the sum of the following losses:

$${Q}^{- 1} = {Q}_{rad}^{- 1} + {Q}_{S . S .}^{- 1} + {Q}_{cont}^{- 1} + {Q}_{mat}^{- 1}$$

where

$${Q}_{rad}^{- 1}$$

represents intrinsic radiative loss,

$${Q}_{S . S .}^{- 1}$$

denotes scattering loss due to residual surface inhomogeneities,

$${Q}_{cont}^{- 1}$$

refers to surface contaminant loss, and

$${Q}_{mat}^{- 1}$$

corresponds to material loss. Among these

$${Q}_{rad}^{- 1}$$

is a loss determined by the curvature of the resonator. In general, as the diameter of the resonator increases, the incident angle of light entering the inner wall of the resonator also increases, leading to a reduction in loss and consequently resulting in a higher Q-factors [7]. However, symmetry also plays a crucial role in determining the Q-factor. Achieving perfect symmetry in larger-diameter MBRs can be challenging, which may result in slightly lower Q-factors. Nevertheless, MBRs in the millimeter scale fabricated using the automatic rotation system maintain a certain degree of symmetry, enabling them to achieve relatively high Q-factors.

In conclusion, we developed an automated rotation system that ensures uniform CO₂ laser heating along the entire circumference of the silica capillary tubes within a specific longitudinal section. This setup enabled the direct use of commercial capillary tubes to fabricate symmetric, spherical MBRs, validating the effectiveness of our fabrication system. Unlike conventional MBR fabrication methods that require pre-tapering processes to achieve uniform heating, our technique eliminates this step, simplifying the production process and enhancing reproducibility. Furthermore, by experimentally demonstrating the influence of laser power and internal pressure on the expansion rate and final size of MBRs, we established a versatile framework for tailoring resonator dimensions to specific applications. Importantly, we confirmed that the fabricated MBRs exhibit Q-factors exceeding 10⁷, demonstrating their potential as high-performance resonators despite their millimeter-scale dimensions. Future research will focus on integrating these MBRs into microfluidic biosensing platforms to leverage their large volume and high Q-factor capabilities. Additionally, the optical properties of thin-walled, millimeter-sized spherical resonators will be explored, as they present intriguing opportunities for advanced photonic applications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. X. Jiang, A. J. Qavi, S. H. Huang, and L. Yang, Matter 3, 371 (2020).
2. D. Yu, M. Humar, K. Meserve, R. C. Bailey, S. N. Chormaic, and F. Vollmer, Nature Reviews Methods Primers 1, (2021).
3. L. He, Ş. K. Özdemir, J. Zhu, W. Kim, and L. Yang, Nat Nanotechnol 6, 428 (2011).
4. M. D. Baaske, M. R. Foreman, and F. Vollmer, Nat Nanotechnol 9, 933 (2014).
5. Q. Xu, B. Schmidt, S. Pradhan, and M. Lipson, Nature 435, 325 (2005). J. Zhu, S. K. Ozdemir, Y. F. Xiao, L. Li, L. He, D. R. Chen, and L. Yang, Nat Photonics 4, 46 (2010).
7. M. L. Gorodetsky, A. A. Savchenkov, and V. S. Ilchenko, (1996), 21.
8. S. Maayani, L. L. Martin, and T. Carmon, Nat Commun 7, (2016).
9. X. Hao, M. Li, S. Zhang, M. Yu, P. An, C. Wang, M. Yang, J. Ren, R. Shen, and Z. Wu, Opt Laser Technol 183, (2025).
10. J. Jiang, Y. Liu, K. Liu, S. Wang, Z. Ma, Y. Zhang, P. Niu, L. Shen, and T. Liu, Appl Opt 59, 5052 (2020).
11. S. Berneschi, D. Farnesi, F. Cosi, G. N. Conti, S. Pelli, G. C. Righini, and S. Soria, (2011).
12. M. Sumetsky, Y. Dulashko, and R. S. Windeler, (2010).
13. A. Watkins, J. Ward, Y. Wu, and S. N. Chormaic, (2011).
14. Y. Yang, S. Saurabh, J. M. Ward, and S. Nic Chormaic, Opt Express 24, 294 (2016).
15. H. Li and X. Fan, Appl Phys Lett 97, (2010).
16. L. T. Hogan, E. H. Horak, J. M. Ward, K. A. Knapper, S. Nic Chormaic, and R. H. Goldsmith, ACS Nano 13, 12743 (2019).
17. A. Cosci, F. Quercioli, D. Farnesi, S. Berneschi, A. Giannetti, F. Cosi, A. Barucci, G. N. Conti, G. Righini, and S. Pelli, Opt Express 23, 16693 (2015).
18. G. Senthil Murugan, M. N. Petrovich, Y. Jung, J. S. Wilkinson, and M. N. Zervas, Opt Express 19, 20773 (2011).

What is claimed is:

1. A method of fabricating a whispering gallery mode (WGM) optical resonator comprising a microbubble structure, the method comprising:
providing a capillary tube;
sealing a first end of the capillary tube;
connecting a pressure source to a second end of the capillary tube to introduce and maintain a predetermined internal pressure;
mounting the capillary tube onto an automated rotation system configured to rotate the capillary tube in a back-and-forth direction or continuously about its longitudinal axis, wherein the automated rotation system is designed to ensure uniform circumferential heat distribution during fabrication;
aligning a section of the capillary tube with a laser-based optical heating system configured to deliver substantially symmetrical heat from opposing directions;
activating the laser-based optical heating system while rotating the capillary tube, such that a heated portion of the capillary tube softens and expands under internal pressure to form a microbubble; and
ceasing heating and rotation upon formation of the microbubble to yield a microbubble resonator with a high optical quality factor.

2. The method of claim 1, wherein the automated rotation system comprises a rotational motor via custom-designed 3D-printed holders, the custom-designed 3D-printed holders being configured to support the capillary tube without imposing mechanical stress and to allow stable bidirectional rotation during heating.

3. The method of claim 2, wherein the custom-designed 3D-printed holders includes a pillar structure configured to extend from a motor's rotating shaft, the pillar structure having a central groove to support the capillary tube and a lower hole to receive a motor shaft.

4. The method of claim 3, wherein custom-designed 3D-printed holders further comprises wing components that connect the pillar structure to a tube holder, the wing components including latch mechanisms configured to lock into grooves of the tube holder to secure the capillary tube.

5. The method of claim 4, wherein the pillar structure and wing components are assembled using mechanical fasteners comprising bolts and nuts.

6. The method of claim 1, wherein an alignment guide having grooved surfaces stably supports the capillary tube during rotation and reduce vibrations or misalignment.

7. The method of claim 6, wherein a weighted flat structure is placed atop the capillary tube within the grooved surfaces to suppress displacement during rotation.

8. The method of claim 7, wherein a detachment structure is configured to safely secure the capillary tube after microbubble formation, the detachment structure allowing the tube to be fixed at both ends and separated from a rotation system without applying external stress.

9. The method of claim 8, wherein the detachment structure is attachable to the alignment guide and includes adhesive regions for fixing both ends of the capillary tube.

10. The method of claim 1, wherein a rotation angle of the capillary tube is modulated periodically or aperiodically during heating to suppress asymmetrical thermal gradients and to enhance microbubble symmetry.

11. The method of claim 1, wherein the automated rotation system includes a programmable controller for adjusting rotation speed, direction, and angle during fabrication to optimize bubble geometry.

12. The method of claim 1, wherein the capillary tube comprises fused silica.

13. The method of claim 1, wherein the laser-based optical heating system comprises a CO₂ laser, a beam splitter, and a plurality of mirrors configured to direct equal-intensity laser beams onto opposing sides of the capillary tube.

14. The method of claim 1, wherein the automated rotation system comprises a servo motor coupled to an encoder and is programmed to rotate the capillary tube in alternating clockwise and counterclockwise directions.

15. The method of claim 4, wherein a rotation protocol comprises at least one ±180° rotation and at least one ±360° rotation to ensure uniform heat distribution.

16. The method of claim 1, further comprising removing a polymer coating from a surface of the capillary tube prior to heating.

17. The method of claim 1, wherein the internal pressure is regulated using a syringe coupled to the second end via a fluidic connector.

18. The method of claim 1, wherein a diameter of the microbubble is controlled by adjusting at least one of: (i) laser power, (ii) internal pressure, or (iii) heating duration.

19. The method of claim 1, further comprising reconstructing a three-dimensional morphology of the microbubble using video frames from a fabrication process.

20. The method of claim 19, wherein reconstruction comprises applying a machine learning algorithm to segment and render a three-dimensional surface geometry of the microbubble.

21. An apparatus for fabricating a whispering gallery mode (WGM) optical resonator, comprising:
a capillary tube composed of a transparent material and having a sealed end and an opposing pressurizable end;
a pressure source coupled to the opposing pressurizable end and configured to maintain a controlled internal pressure;
a laser-based optical heating system configured to apply substantially symmetrical heat to a selected region of the capillary tube;
a motorized rotation assembly comprising a tube holder and a motor, the tube holder configured to secure and rotate the capillary tube about its longitudinal axis during heating; and
a control system configured to synchronize laser heating and rotation to enable fabrication of a spherical microbubble structure with high optical quality factor.

22. The apparatus of claim 21, wherein the control system comprises a microcontroller programmed to rotate the capillary tube in alternating directions through predefined angular displacements.

23. The apparatus of claim 21, wherein the laser-based optical heating system comprises a CO₂ laser, a beam splitter, and a plurality of mirrors and lenses configured to deliver equal laser power to opposing sides of the capillary tube.

24. A method of detecting an analyte using a microbubble resonator fabricated by the method of claim 1, comprising:
introducing a fluid sample containing the analyte into an interior of the microbubble;
directing a light beam into the microbubble resonator to induce a whispering gallery mode;
and detecting a resonance wavelength shift in response to presence of the analyte.

25. The method of claim 24, wherein the analyte comprises a virus, protein, nucleic acid, gas, or salt ion.

26. A whispering gallery mode (WGM) optical resonator comprising:
a microbubble structure formed from a transparent capillary tube, the microbubble having a spherical or near-spherical geometry, an internal cavity, and a continuous outer wall with a smooth surface, wherein the microbubble is formed by expanding a section of the capillary tube under internal pressure while subjected to symmetrical heating from opposing directions during rotation about its longitudinal axis and wherein the microbubble resonator exhibits an optical quality (Q) factor greater than 10⁶.

27. The resonator of claim 26, wherein the optical quality factor exceeds 10⁷.

28. The resonator of claim 26, wherein an outer wall of the microbubble has a thickness of less than 3 micrometers.

29. The resonator of claim 26, wherein a diameter of the microbubble is between 100 micrometers and 2 millimeters.

30. The resonator of claim 26, wherein the geometry of the microbubble is symmetric about its longitudinal axis with less than 5% deviation in wall thickness along a circumference thereof.

31. The resonator of claim 26, wherein the microbubble is fluidically accessible through opposing ends of the capillary tube for introduction of a liquid or gas sample.

32. The resonator of claim 26, wherein the resonator is integrated into a microfluidic platform for analyte detection via resonance wavelength shifts.

33. A method of detecting nanoparticles using a microbubble resonator fabricated by the method of claim 1, comprising:
introducing a fluid sample containing nanoparticles into an interior of the microbubble, the microbubble resonator having an optical quality factor greater than 10⁷; directing a light beam into the resonator to induce a whispering gallery mode; monitoring a transmission spectrum of the resonator; and detecting mode splitting in the transmission spectrum, wherein a single resonance peak separates into a symmetric mode and an asymmetric mode in response to a presence of the nanoparticles.

34. The method of claim 33, wherein the nanoparticles have a size in a range of 10 nm to 100 nm.

35. The method of claim 33, wherein the nanoparticles include intact virions, and the method provides label-free detection of the virions.

36. The method of claim 33, wherein a degree of mode splitting increases with increasing concentration of nanoparticles within the cavity.

37. The method of claim 33, wherein the detecting comprises quantitatively determining a concentration of the analyte by comparing a measured resonance wavelength shift to a calibration curve established from solutions of known concentrations of the analyte.

38. The method of claim 37, wherein the analyte comprises a salt ion, and the resonance wavelength shift exhibits a linear relationship with a concentration of the salt ion over a predetermined concentration range.
